(19) United States
(12) Patent Application Publication
(10) Pub. No.: US 2016/0117575 A1
(43) Pub. Date: Apr. 28, 2016

(54) IMAGE FORMING APPARATUS AND PRINTING INSPECTION SYSTEM

(71) Applicant: FUJI XEROX CO., LTD., Tokyo (JP)

(72) Inventor: Tatsuji Shimizu, Kanagawa (JP)

(21) Appl. No.: 14/824,130

(22) Filed: Aug. 12, 2015

(30) Foreign Application Priority Data
Oct. 24, 2014 (JP) 2014-217387

(51) Int. Cl. G06K 15/02

(52) U.S. Cl. CPC G06K 15/027; G06K 15/1878

(57) ABSTRACT

An image forming apparatus includes: an image forming section that forms an image on a recording medium using color material having color and transparent color material; a reading section that reads the image formed on the recording medium by the image forming section; and a reference data calculation section that calculates reference data based on read data obtained when the reading section reads a first color sample which is formed using only the color material having color by the image forming section and a second color sample which is formed using the color material having color and the transparent color material by the image forming section; and in which an image on the recording medium, which is an inspection target and is read by the reading section, is inspected by an inspection section based on the reference data calculated by the reference data calculation section.

### CROSS-REFERENCE TO RELATED APPLICATIONS

This application is based on and claims priority under 35 USC 119 from Japanese Patent Application No. 2014-217387 filed on Oct. 24, 2014.

### BACKGROUND

### Technical Field

The present invention relates to an image forming apparatus and a printing inspection system.

### SUMMARY

An aspect of the invention provides an image forming apparatus including: an image forming section that forms an image on a recording medium using color material having color and transparent color material; a reading section that reads the image formed on the recording medium by the image forming section; and a reference data calculation section that calculates reference data based on read data obtained when the reading section reads a first color sample which is formed using only the color material having color by the image forming section and a second color sample which is formed using the color material having color and the transparent color material by the image forming section; and in which an image on the recording medium, which is an inspection target and is read by the reading section, is inspected by an inspection section based on the reference data calculated by the reference data calculation section.

### BRIEF DESCRIPTION OF THE DRAWINGS

Exemplary embodiment(s) of the present invention will be described in detail based on the following figures, wherein

FIG. 1 is a schematic diagram illustrating an outline of a printing inspection system according to an embodiment of the invention;

FIG. 2 is a schematic diagram illustrating an image forming apparatus main body being used in the embodiment of the invention;

FIG. 3 is a block diagram illustrating the printing inspection system according to the embodiment of the invention;

FIG. 4A is a color chart used in the embodiment of the invention, in which color material having color is only used;

FIG. 4B is a color chart used in the embodiment of the invention, for which transparent color material also used;

FIG. 5 is a flow chart illustrating an example of an operation which is performed in advance in the printing inspection system according to a first embodiment of the invention;

FIG. 6 is a flow chart illustrating an example of an operation of the printing inspection system according to the first embodiment of the invention;

FIG. 7 is a schematic diagram illustrating an example of a screen which is displayed on a user interface;

FIG. 8 is a flow chart illustrating an example of an operation of a printing inspection system according to a second embodiment of the invention; and

FIG. 9 is a schematic diagram illustrating an example of an image printed on a recording sheet.

### DETAILED DESCRIPTION

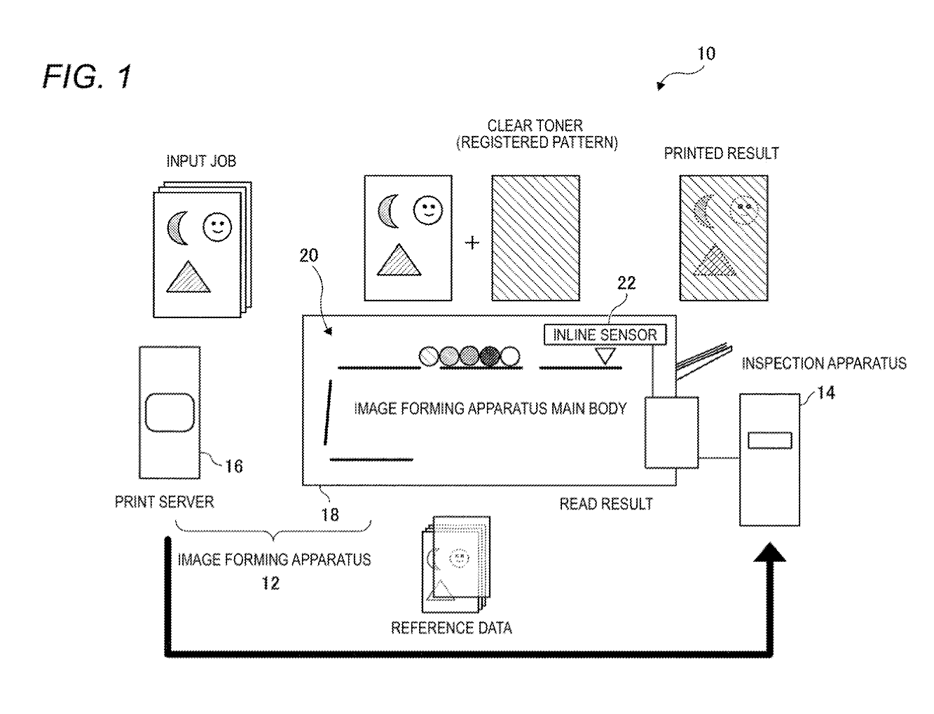

Hereinafter, exemplary embodiment(s) of the invention will be described in detail with reference to drawings. FIG. 1 illustrates a printing inspection system according to a first embodiment of the invention. A printing inspection system 10 includes an image forming apparatus 12 and an inspection apparatus 14. In the first embodiment, the image forming apparatus 12 is configured to have a print server 16 which is an external controller and an image forming apparatus main body 18.

The print server 16 receives an input job, processes the received input job, and transmits a resultant to the image forming apparatus main body 18. The image forming apparatus main body 18 includes an image forming section 20 which forms an image on a recording medium with color material having color and transparent color material. In addition, the image forming apparatus main body 18 is provided with a reading section (inline sensor) 22 which reads an image formed by the image forming section 20. The inspection apparatus 14 inspects the recording medium on which the image is formed by the image forming apparatus main body 18. An inspection of the inspection apparatus 14 is performed based on reference data transmitted from the print server 16.

Moreover, in the image forming apparatus 12, the print server 16 may be integrated with the image forming apparatus main body 18. In addition, a reading section 22 does not need to be provided in the image forming apparatus main body 18, and can be provided outside the image forming apparatus main body 18. Further, the inspection apparatus 14 can be integrated with the image forming apparatus 12.

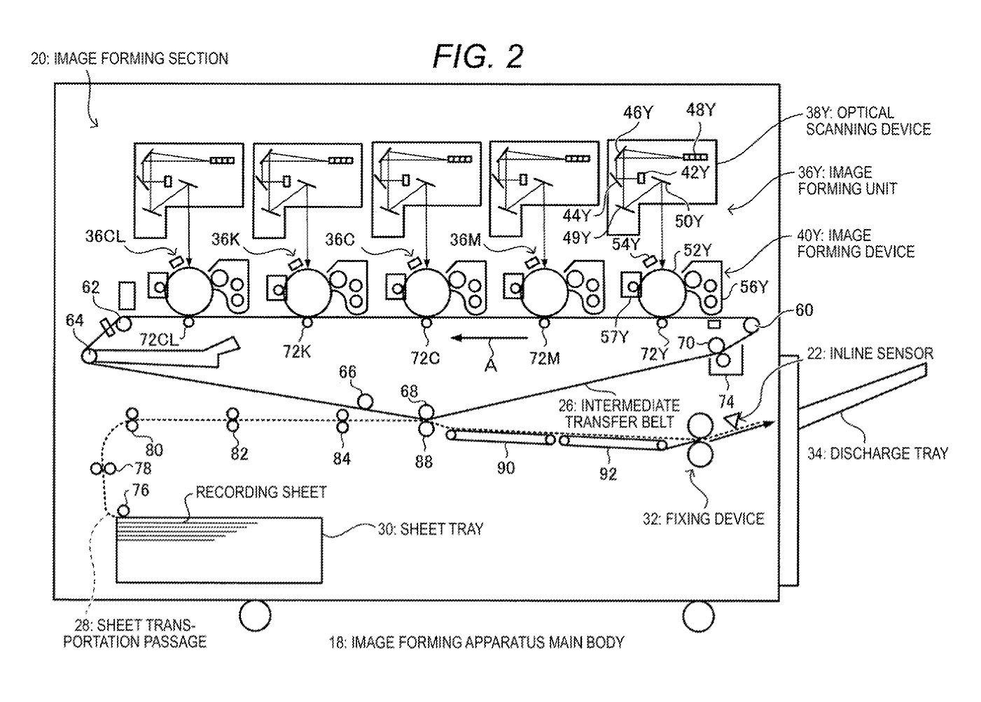

In FIG. 2, the image forming apparatus main body 18 is illustrated. The image forming section 20 includes an image forming unit 36, an intermediate transfer belt 26, a sheet transportation passage 28, a sheet tray 30, a fixing device 32, a discharge tray 34, and the like, and prints the image on the recording medium using the color material based on the print data transmitted from the print server 16.

In the image forming section 20, plural image forming units 36 are disposed to form a transparent image and a colored image. That is, in the embodiment, next to image forming units which form image with the color material having color such as yellow (Y), magenta (M), cyan (C), and black (K), an image forming unit 36CL which forms the transparent image with transparent (CL) color material is provided. Moreover, in the embodiment, an example in which toners are used as the color material, and printing is performed in an electrophotographic manner is described; however, the embodiment may be configured in an ink jet printer. Here, each image forming unit 36, for example, is horizontally arranged along an intermediate transfer belt 26 at predetermined intervals. The intermediate transfer belt 26 is rotated in a direction of an arrow A illustrated in FIG. 2 as an intermediate transfer body.

Five image forming units 36Y, 36M, 36C, 36K, and 36CL sequentially form toner images of each color based on the input image data, and transfer the images to the intermediate transfer belt 26 (primary transferring) at the time when the plural toner images are overlapped with each other. Moreover, an order of colors of each of the image forming units 36Y, 36M, 36C, 36K, and 36CL is not limited to this order, and the image forming units 36Y, 36M, 36C, and 36K may be in any order as long as the image forming unit 36CL becomes the last one.

The sheet transportation passage 28 is disposed lower than the intermediate transfer belt 26. The recording sheet which is the recording medium supplied from the sheet tray 30 is transported through the sheet transportation passage 28. The toner images of each color multi-transferred on the intermediate transfer belt 26 are seamlessly transferred (Secondary transferring) to the recording sheet, and the transferred toner image is fixed to the recording sheet by the fixing device 32. Then, the recording sheet is discharged to the discharge tray 34 along an arrow B.

The first image forming unit 36Y, the second image forming unit 36M, the third image forming unit 36C, the fourth image forming unit 36K, and the fifth image forming unit 36CL are disposed in parallel in a horizontal direction with predetermined intervals, and have the same configuration except that a color of an image being formed is different. Therefore, hereinafter, the first image forming unit 36Y will be described. Moreover, each configuration of the image forming units 36 is distinguished by Y, M, C, K and CL.

The image forming unit 36Y includes a optical scanning device 38Y which performs scanning with laser light corresponding to the input image data and image forming device 40Y which forms an electrostatic latent image by laser light emitted from the optical scanning device 38Y.

The optical scanning device 38Y modulates a semiconductor laser 42Y in accordance with yellow (Y) image data, and emits the laser light using the semiconductor laser 42Y in accordance with the image data. The laser light emitted from the semiconductor laser 42Y is applied to a rotary polygon mirror 48Y through a first reflection mirror 44Y and a second reflection mirror 46Y, is caused to travel being deflected by the rotary polygon mirror 48Y, and then is applied onto a photoreceptor drum 52Y of the image forming device 40Y through the second reflection mirror 46Y, a third reflection mirror 49Y, and a fourth reflection mirror 50Y.

The image forming device 40Y is configured to have the photoreceptor drum 52Y as an image carrier which is rotated at a predetermined rotation speed along the direction of the arrow A, a scorotron 54Y for primary electrification as a charging section for uniformly charging a surface of the photoreceptor drum 52Y, a developing device 56Y which develops the electrostatic latent image formed on the photoreceptor drum 52Y, and a cleaning device 57Y. The photoreceptor drum 52Y is uniformly charged by the scorotron 54Y, and the electrostatic latent image is formed on the photoreceptor drum 52Y by the laser light emitted from the optical scanning device 38Y. The electrostatic latent image formed on the photoreceptor drum 52Y is developed by the developing device 56Y using the yellow (Y) toner, and is transferred to the intermediate transfer belt 26. Moreover, after a transfer process of the toner image, remained toner, paper powder, or the like attached to the photoreceptor drum 52Y is removed by the cleaning device 57Y.

The intermediate transfer belt 26 is wound around between a driving roll 60, a first idle roll 62, a steering roll 64, a second idle roll 66, a backup roll 68, and a third idle roll 70 at a predetermined tension. Since the driving roll 60 is rotatably driven by a driving motor (not illustrated), the intermediate transfer belt 26 is moved to be circulated at a predetermined speed in the direction of the arrow A. The intermediate transfer belt 26, is formed, for example, in an endless belt shape by forming a belt shaped synthetic resin film of polyimide or the like having flexibility and connecting both ends of the formed belt shape synthetic resin film to each other by welding, or the like.

In addition, in the intermediate transfer belt 26, a first primary transferring roll 72Y, a second primary transferring roll 72M, a third primary transferring roll 72C, a fourth primary transferring roll 72K, and a fifth primary transferring roll 72CL are respectively disposed at a position facing each of image forming units 36Y, 36M, 36C, 36K, and 36CL, and each of toner images formed on the photoreceptor drums 52Y, 52M, 52C, 52K, and 52CL is multi-transferred on the intermediate transfer belt 26 by the primary transferring roll 72. Moreover, the remained toner attached to the intermediate transfer belt 26 is removed by a cleaning blade or a brush of a belt cleaning device 74 provided on a downstream side of a secondary transferring position.

In the sheet transportation passage 28, a supply roller 76 which pulls the recording sheet from the sheet tray 30, a first pair of rollers 78, a second pair of rollers 80, and a third pair of rollers 82 for transporting sheets, and a resist roll 84 which transports the recording sheet to the secondary transferring position at a predetermined timing are disposed.

In addition, in the secondary transferring position on the sheet transportation passage 28, a secondary transferring roll 88 is pressure-welded on the backup roll 68 is disposed, and each toner image multi-transferred on the intermediate transfer belt 26 is secondary transferred on the recording sheet by pressure-welding force and electrostatic force by the secondary transferring roll 88. The recording sheet on which the toner images of each color are transferred is transported to the fixing device 32 by a first transportation belt 90 and a second transportation belt 92.

The fixing device 32 melts and fixes the toner onto the recording sheet by performing a heat and pressurization process on the recording sheet onto which each color toner image is transferred. The recording sheet subjected to the pressurization process by the fixing device 32 is discharged to the discharge tray 34.

In the sheet transportation passage 28 between the fixing device 32 and the discharge tray 34, the above described inline sensor 22 is provided. The inline sensor 22, for example, is an optical image sensor. The inline sensor 22 can obtain the image data by scanning the recording sheet on which the image is printed.

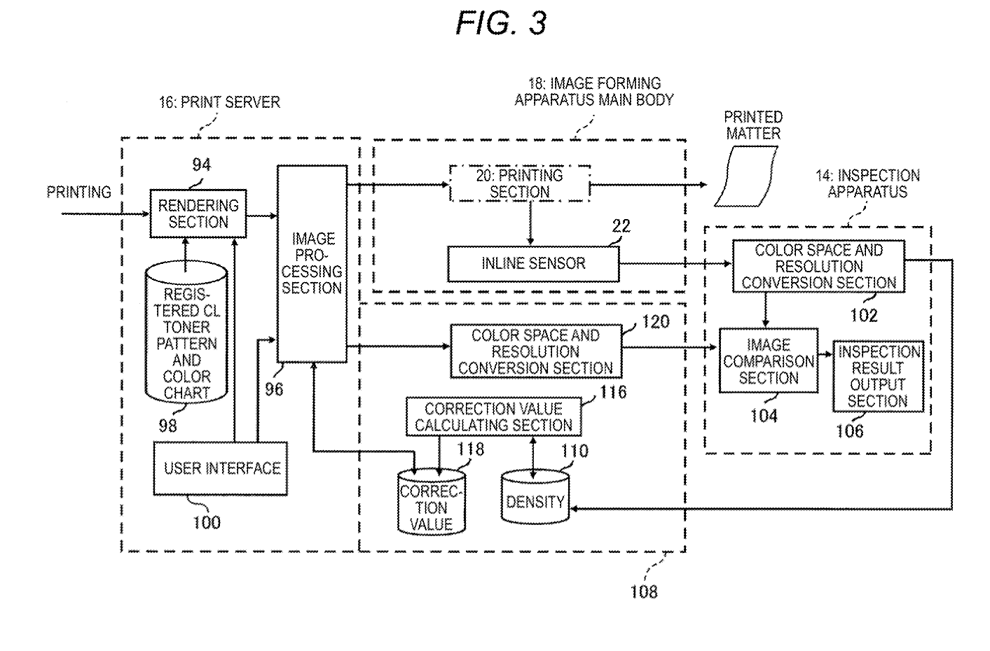

FIG. 3 is a block diagram of the printing inspection system according to the embodiment of the invention.

The print server 16 includes a rendering section 94, an image processing section 96, a storage section 98, and a user interface 100. A color chart (color sample) for calibration or a registered pattern of the transparent color material (CL toner) is stored in the storage section 98. The user can select and designate the type of the recording sheet which is printed or a part where color material for transparent color to be described later (CL toner) is combined using the user interface 100.

The inspection apparatus 14 includes a color space and resolution conversion section 102, an image comparison section 104, and an inspection result output section 106.

The rendering section 94 renders an input image based on the input print data. In addition, the rendering section 94, based on a designation from the user interface 100, renders the color chart or the registered pattern of the transparent color material. The image processing section 96 respectively transmits rasterized image data Y, M, C, K, and CL to a printing section 20 of the image forming apparatus main body 18.

In the image forming apparatus main body 18 forms the image is printed on the recording sheet by the printing section 20 based on the data transmitted from the image processing section 96. The image for inspection printed on the recording sheet is read by the inline sensor 22 and is transmitted to the inspection apparatus 14.

The inspection apparatus 14 allows the color space and resolution conversion section 102 to convert the image which is read by the inline sensor 22 and inputs the converted image to the image comparison section 104. The image comparison section 104 compares the image data for inspection converted by the color space and resolution conversion section 102 with the reference data output from the reference data calculating section 108 of the print server 16. A comparison result in the image comparison section 104 is output to the inspection result output section 106. The inspection result output section 106, for example, is a display device, and displays the inspection result.

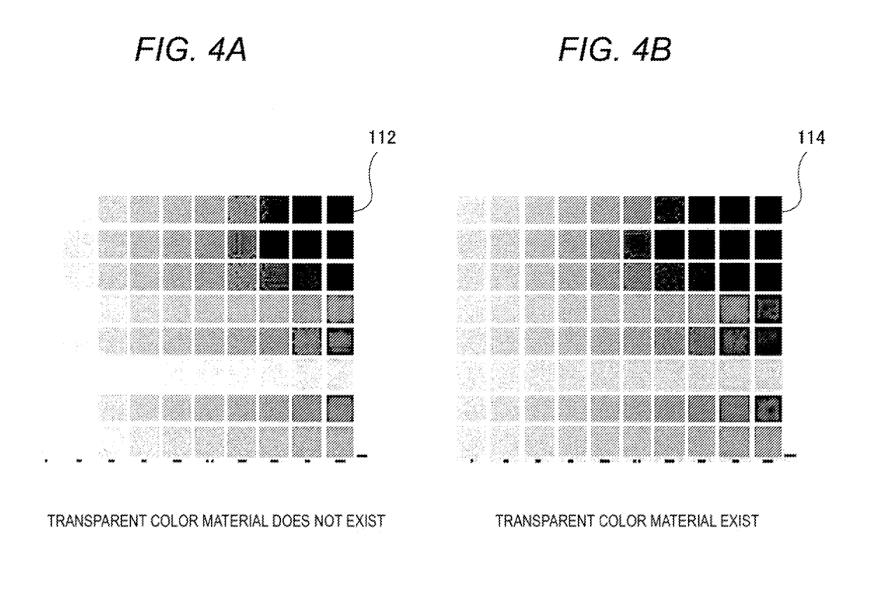

The reference data calculating section 108 includes a density storage section 110. In the density storage section 110, density data obtained from two types color charts output by the color space and resolution conversion section 102 of the inspection apparatus 14 is stored. That is, a first color chart 112 illustrated in FIG. 4A and a second color chart 114 illustrated in FIG. 4B are read by the inline sensor 22, are converted by the color space and resolution conversion section 102, and are stored in the density storage section 110. The first color chart 112 is formed by only the color material having color and formed as a patch in which the density is changed for every color. The second color chart 114 is obtained by covering the entire surface of the first color chart 112 with the transparent color material.

A correction value calculating section 116 calculates a correction value based on the density data of the density storage section 110. In the embodiment, the correction value calculating section 116 calculates a difference between a value read from the first color chart 112 and a value read from the second color chart 114. The correction value calculated by the correction value calculating section 116 is stored in a correction value storage section 118.

In the image processing section 96 of the print server 16, the reference data is calculated by correcting the image for inspection formed using the transparent color material with the correction value stored in the correction value storage section 118. The reference data is converted to be suitable for the inspection apparatus 14 by the color space and resolution conversion section 120, and the resultant data is transmitted to the image comparison section 104 of the inspection apparatus 14 described above.

Moreover, a process of the color space and resolution conversion section 120 may be performed by a software; however, a hardware may be used for high speed processing.

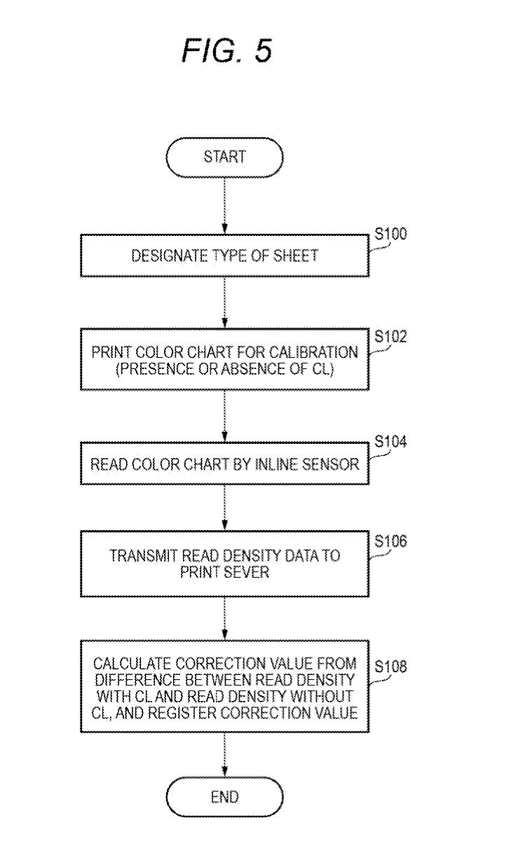

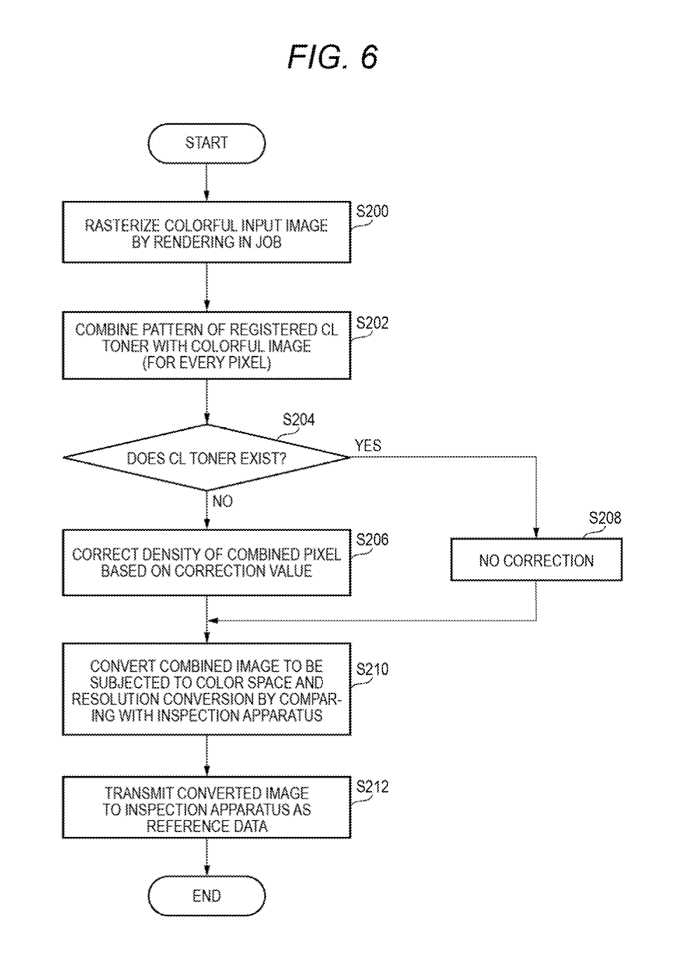

Next, an operation of the printing inspection system according to the embodiment of the invention will be described with reference to flow charts of FIGS. 5 and 6.

FIG. 5 is a flow chart illustrating an example of an operation performed in advance in the printing inspection system (refer to FIG. 3) according to the embodiment. In this process, the correction value described above is calculated using the color chart for calibration stored in advance in the print server 16 before the inspection process of the inspection apparatus 14. Since the data for calibration is changed by quality of the recording sheet 24 on which the image is printed (for example, surface roughness, presence or absence of gloss, or the like), it is preferable that the process is performed for every paper quality.

In Step 100 (S100), the sheet type of the recording sheet is designated through the user interface 100. In Step 102 (S102), the color chart for calibration is printed on the designated sheet type of the recording sheet by the printing section 20. The color chart printed at first is the image (illustrated in FIG. 4A) formed by only the color material having color which is not combined with the transparent color material (CL toner), and the color chart printed second is the image (illustrated in FIG. 4B) which is combined with the transparent color material (CL toner).

In Step 104 (S104), each color chart is read by the inline sensor 22 and is subjected to a color space and resolution conversion by the color space and resolution conversion section 102 of the inspection apparatus 14.

In Step 106 (S106), the density data obtained by the color space and resolution conversion section 102 is stored in the density storage section 110. In the stored density data, information relating to the sheet type and information on whether or not the transparent color material (CL toner) is combined are added as a tag for identification.

In Step 108 (S108), the correction value calculating section 116 reads the density data stored in the density storage section 110, calculates a correction value from a difference between the density in a case of combining the transparent color material and the density in a case of not combining the transparent color material and stores the calculated value in the correction value storage section 118. The information relating to the sheet type is added in the stored correction value as the tag for identification.

As described above, the image comparison section 104 of the inspection apparatus 14 compares the image data for inspection read by reading the image printed on the recording sheet by the inline sensor 22 with the reference data obtained from the print server 16, and thus the inspection is performed. An creation process of the reference data will be described with reference to the flow chart in FIG. 5.

The print data described in a printing job may include, the image formed using only the color material having color and the image formed using the transparent color material. When the image combined with the transparent color material is printed on the recording sheet, regarding which part of the sheet is applied with the transparent color material, the user can select and designate one in several choices. The choices which are possible to be designated will be described later; however, for example, the transparent color material can be combined according to the registered pattern (shapes, area, or the like). Examples of above described cases will be described.

When the print server 16 receives the printing job, in Step 200 (S200), the rendering section 94 raterizes a colorful input image based on the print data including the image formed using only the color material having color and the image formed using the transparent color material.

In Step 202 (S202), the rendering section 94 reads the pattern of the transparent color material registered in the storage section 98, and the pattern is combined for every pixel of the colorful image rasterized in Step 200 and is input to the image processing section 96.

In Step 204 (S204), the image processing section 96 determines whether or not the transparent color material exists. When the transparent color material is present, the process goes to Step 206, but when the transparent color material does not existed, the process goes to Step 208.

When the transparent color material exists (YES in Step 204), in Step 206 (S206), the image processing section 96 obtains the correction value stored in the correction value storage section 118 and corrects the density of combine pixels based on the correction value. When the transparent color material does not existed (NO in Step 204), the image processing section 96 performs correction on the only colorful pixel in Step 208 (S208).

Data of each pixel processed in Step 206 (S206) and Step 208 (S208) becomes the reference data by being subjected to the color space and resolution conversion by the color space and resolution conversion section 120. In Step 212 (S212), the reference data is transmitted to the image comparison section 104 of the inspection apparatus 14.

When the reference data is input, the image comparison section 104 compares the image data for inspection read by the inline sensor 22 from the printed recording sheet with the input reference data so that printing quality is evaluated. The inspection result output section 106 outputs the evaluation result from the image comparison section 104 as an inspection result. An output method may be a display method or may be other methods.

As described above, when the image combined with the transparent color material is printed on a sheet (recording sheet 24), regarding which part of the sheet is applied with the transparent color material, the user can select and designate one in several choices.

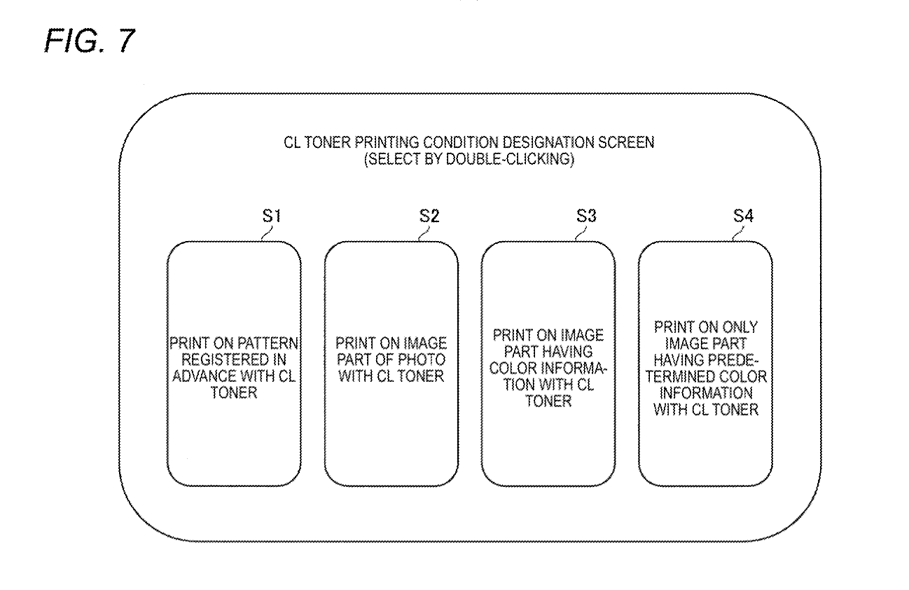

FIG. 7 is a schematic diagram illustrating an example of a transparent color material (CL toner) printing condition designating screen displayed on the user interface 100. In the screen, a selection image S1 for selecting “print on pattern registered in advance with CL toner”, a selection image S2 for selecting “print on image part on photo with CL toner”, a selection image S3 for selecting “print on image part having color information with CL toner”, and a selection image S4 for selecting “print on only image part having predetermined color information with CL toner” are displayed. The user can designate a printing condition by double-clicking a desired selection image, or the like.

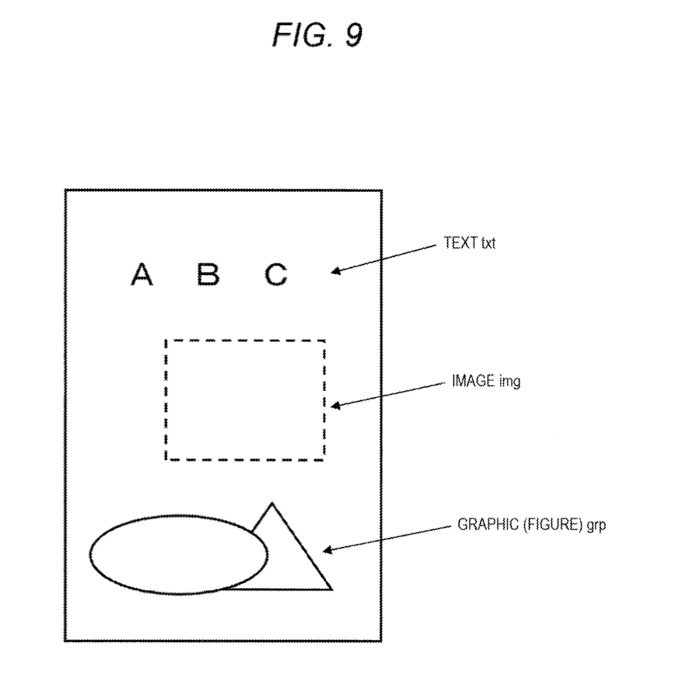

FIG. 9 is a schematic diagram illustrating an example of the printed image. In the image (target), as illustrated in FIG. 9, there are a text txt, an image img such as a photo, a graphics grp such as a figure. Also, there are many cases in which these targets exists on the recording sheet. When the transparent color material (CL toner) is combined with a part of image img such as a photo and then printed, glossiness thereof increases. When the CL toner is printed on the part of the image img, the selection image S2 may be selected in a screen of FIG. 7.

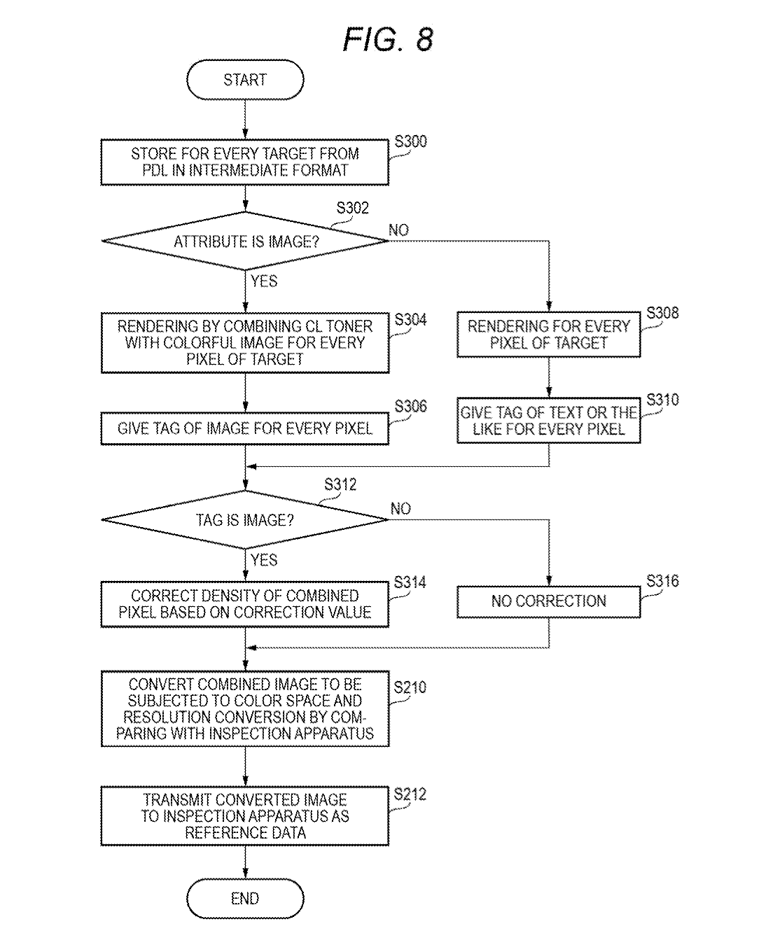

When the colorful image is combined with the transparent color material, the transparent color material may be deviated. For example, when selecting and designating a condition that a part of the image img in FIG. 8 is combined with the transparent color material, the transparent color material may be deviated from the part of the image img.

In the printing inspection system according to a second embodiment of the invention, the image comparison section 104 detects a deviation of the transparent color material. Hereinafter, an example of a case in which a part of the image img is combined with the transparent color material will be described.

FIG. 8 is a flow chart illustrating an operation example of the printing inspection system according to the second embodiment.

In Step 300 (S300), the rendering section 94 divides each target from a PDL described in the printing job, gives attribute to every target, and temporarily stores the target in an intermediate format. The storage section 98 is used as storage thereof.

In Step 302 (S302), the rendering section 94 reads the temporarily stored target and determines whether or not attribute of the target is the image. When the target is the image, the process goes to Step 304 (S304), but when the target is not the image, the process goes to Step 308 (S308).

When the target is the image (YES in Step 302), in Step 304 (S304), the rendering section 94 combines the CL toner and performs rendering for every pixel of the target, and a tag of the image is given to every pixel in Step 306 (S306).

When the target is not the image (NO in Step 302), in Step 308 (S308), the rendering section 94 performs rendering for every pixel of the target, and in Step 310 (S310), a tag corresponding to the text is given to every pixel.

The combined pixels and the pixel data to which each tag is given in the processes of Step 306 (S306) and Step 310 (S310), are input to the image processing section 96.

In Step 312 (S312), the image processing section 96 determines whether or not the tag of the pixel data is the image. When the pixel is the image, the process goes to Step 314 (S314), but when the pixel is not the image, the process goes to Step 316 (S316).

When the tag is the image (YES in Step 312), in Step 314 (S314), the image processing section 96 obtains the correction value stored in the correction value storage section 118, and corrects the density of the combined pixel based on the correction value.

When the tag is not the image (NO in Step 12), in Step 316 (S316), the image processing section 96 does not correct the only colorful pixel. The data of each pixel processed in Step 314 (S314) and Step 316 (S316) is transmitted to the image forming apparatus main body 18.

The subsequent processes of Step 210 (S210) and Step 212 (S212) are performed in the same method as that of the process of the flow chart in FIG. 6.

In Step 210 (S210), the reference data for comparison by the image comparison section 104 of the inspection apparatus 14 is generated. The color space and resolution conversion section 120 of the reference data calculating section 108 performs the color space and resolution conversion on the combined pixel (process result of Step 314) which is corrected and transmitted from the image processing section 96 and the uncorrected pixel (process result of Step 316), and thus the resultant becomes the reference data. In Step 212 (S212), the reference data is transmitted to the image comparison section 104 of the inspection apparatus 14.

When the reference data is input, the image comparison section 104 compares the image data for inspection which is read by the inline sensor 22 from the printed recording sheet and is combined with the transparent color material, with the image (image combined with transparent color material) by the corrected combined pixel (process result of Step 314) in the reference data, and then detects the deviation of the transparent color material.

For example, the image comparison section 104 can evaluate that the density for inspection with which the transparent color material is combined read from the printed recording sheet by the inline sensor 22 is different from the density of the corrected and combined image in the reference data, in response to an amount deviated horizontally and vertically from the target which is the image.

The deviation amount of the transparent color material detected by the image comparison section 104 is transmitted the print server 16 through the inspection result output section 106, such that the image forming apparatus main body 18 can print the revised image based on the deviation amount on the recording sheet.

Moreover, in the embodiment, the correction value is calculated based on density differences obtained by respectively reading the first color chart and the second color chart, and the image including the transparent color material is corrected by the correction value so as to become the reference data; however, the invention is not limited thereto. For example, the first color chart and the second color chart are respectively read and the read data is stored as it is. Also, the reference data may be calculated with respect to the image formed by only the color material having color and the image including the transparent color material, respectively. In addition, the correction value is calculated based on the density differences obtained by respectively reading the first color chart and the second color chart, and the image including only the color material having color, which is not the image including the transparent color material, may be corrected by the correction value.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming section that forms an image on a recording medium using color material having color and transparent color material;
a reading section that reads the image formed on the recording medium by the image forming section; and
a reference data calculation section that calculates reference data based on read data obtained when the reading section reads a first color sample which is formed using only the color material having color by the image forming section and a second color sample which is formed using the color material having color and the transparent color material by the image forming section; and
wherein an image on the recording medium, which is an inspection target and is read by the reading section, is inspected by an inspection section based on the reference data calculated by the reference data calculation section.

2. The image forming apparatus according to claim 1,
wherein the reference data calculation section calculates the reference data based on a correction value obtained from a difference between read densities of the first color sample and the second color sample.

3. The image forming apparatus according to claim 2,
wherein the reference data calculation section calculates the reference data by correcting an image for which the transparent color material is used with the correction value.

4. The image forming apparatus according to claim 1, further comprising:
a reception section that receives a designation of an target for forming an image using transparent color material.

5. A printing inspection system comprising:
an image forming section that forms an image on a recording medium using color material having color and transparent color material;
a reading section that reads the image formed on the recording medium by the image forming section;
a reference data calculation section that calculates reference data based on read data obtained when the reading section reads a first color sample which is formed using only the color material having color by the image forming section and a second color sample which is formed using the color material having color and the transparent color material by the image forming section; and
an inspection section that inspects an image on the recording medium which is an inspection target formed by the image forming section based on the reference data calculated by the reference data calculation section.

6. The printing inspection system according to claim 5,
wherein the inspection section includes a comparison section that compares the reference data calculated by the reference data calculation section with data for inspection of the recording medium which is the inspection target read by the reading section.

7. The printing inspection system according to claim 5,
wherein the inspection section includes an output section which outputs an inspection result.

8. The printing inspection system according to claim 7,
wherein the output section outputs a deviation of a region to be formed using the transparent color material.
